(19) United States
(12) Patent Application Publication
(10) Pub. No.: US 2007/0201646 A1
(43) Pub. Date: Aug. 30, 2007

(54) Callback Service

(75) Inventor: Michael D. Metcalf, Ladera Ranch, CA (US)

Correspondence Address: DAVID L. THOMSON, 4480 BASSWOOD DR., LISLE, IL, 60532, US

(73) Assignee: MDM INTELLECTUAL PROPERTY LLC, Rancho Santa Margarita, CA (US)

(21) Appl. No.: 11/307,677

(22) Filed: Feb. 16, 2006

(51) Int. Cl. H04M 1/56; H04M 15/06

(52) U.S. Cl. 379/142.01

(57) ABSTRACT

A caller calls a callback system. If the caller is not a subscriber, the caller is offered a subscription, and if the caller provides proper billing information, the caller becomes a subscriber. When a subscriber calls a callback system, the system identifies the subscriber's ANI and calls the subscriber back. The system connects the subscriber to a destination chosen by the subscriber.

### FIELD OF THE INVENTION

The present invention relates to telecommunications systems and methods and, more particularly, to a method where a first party calls a system, hangs up, and the system calls the first party back and then the system calls a second party and connects the first party to the second party.

### BACKGROUND OF THE INVENTION

Telephone service providers frequently offer pricing plans with different rates for incoming and outgoing calls. For example, with some plans, customers pay for outbound calls, either by a fixed charge for a specified number of minutes or on a per-minute basis, but receive free unlimited incoming calls as part of the service package. In particular, certain cellular service plans allow free incoming minutes. Subscribers to free incoming minute plans benefit from the free incoming minutes only when someone calls them, but must to use up limited monthly allocations of minutes or pay per-minute when placing an outbound call.

Customers on free incoming minute plans would benefit from having a large percentage of their calls be inbound, since these calls are free, and a small percentage outbound, which are metered and charged. However, when customers wish to initiate a call, there is currently no easy was for them to avoid using up outbound minutes or paying a per-minute charge. A customer (i.e. the calling party) may call the person he/she wishes to speak to (i.e. the called party) and ask that person to call him/her back, but this solution is socially awkward because it makes the calling party appear cheap and it may be financially disadvantageous if the called party must then pay service provider fees for returning the call. What is needed is a method for a customer to initiates calls and take maximum advantage of free incoming minutes.

### SUMMARY OF THE INVENTION

In accordance with one aspect of the invention, the aforementioned problem has been solved and a technological advance achieved by providing a callback service where the calling party notifies a callback system that he/she wishes to place a call and the callback system connects the calling party and the called party. Said notification may occur via a call to a local number, long-distance, or 800 (or other toll-free) number, an SMS (short message service) or other text messaging service, a VoIP call, an email message, or by other means. The callback service may be configured to collect the telephone number of the called party either during the notification stage or after the callback. This solution causes the call to appear as an inbound call for both parties, thus minimizing service provider charges.

For the service to be successful in the market, it is useful to offer the customer a solution that either costs less than what the customer would otherwise pay for outbound minutes or it must add greater value for the customer. This invention does both. Costs are kept low through use of VoIP (Voice over Internet Protocol), allowing the customer to save money and enabling the callback service provider to earn revenue. Value to the customer is enhanced by the ability to offer a set of new features such as sequence calling, name dialing, voice activation, personalized greeting, and delayed callback on busy.

A callback service presents a service provider with an opportunity to charge for the callback service, therefore it is advantageous for the service to include the ability to subscribe and charge customers and collect billing information. Subscription may be performed with telemarketing, by bundling a callback service with other services, on the Internet, via sales of prepaid services such as prepaid telephone cards, by way of an up-sell offer in conjunction with an existing service, by collecting a credit card number or other billing information from the customer when he/she first uses the callback service or calls a subscription center, or by other means used to sign up customers.

### BRIEF DESCRIPTION OF THE DRAWINGS

FIG. 1 shows a sample architecture for a callback configuration.

FIG. 2 shows a sample hardware configuration for callback system.

FIG. 3 shows an example sequence of events.

FIG. 4 shows a method for offering callers a subscription.

FIG. 5 shows a method for manual ANI collection.

FIG. 6 shows a method for checking ANI with no manual ANI collection.

FIG. 7 shows a method for sequence calling.

FIG. 8 shows a method for early number collection.

FIG. 9 shows a method for simultaneous calling.

FIG. 10 shows a sample architecture using VoIP.

FIG. 11 shows a method for SMS/text/email/IM activation.

FIG. 12 shows a method for SMS/text/email/IM activation with simultaneous callback.

FIG. 13a shows an example of callback registration

FIG. 13b shows a call flow for a callback start dialog

FIG. 13c shows an account menu dialog

FIG. 13d shows a trial expired dialog

FIG. 13e shows an account issue dialog

FIG. 14 shows a method for callback connection to a communication assistant.

### DETAILED DESCRIPTION

In the following description, numerous details are set forth to provide an understanding of the present invention. However, it is to be understood by those skilled in the art that the present invention may be practiced without these details and that numerous variations or modifications from the described embodiments may be possible.

Terms

In the invention disclosure and claims, certain words are used for convenience; however it is understood that they are merely examples and represent a class of definitions. To list all possible examples each time an term is mentioned would be tedious, therefore, the following words can take on meanings as follows:

ASR: Automatic Speech Recognition.

Caller: Also called “calling party.” The terms “caller” and “caller's telephone” are sometimes used interchangeably. We refer, for example, to the caller's ANI, meaning the ANI associated with the telephone used by the caller, even though the caller is a person and technically has no ANI. We sometimes refer to a caller as a subscriber and vice-versa, since the callback service may be sold as a subscription service.

Caller ID: Caller identification. Also called ANI (Automatic Number Identification) refers to the ability of a callback system to detect an identifier used to call the caller back. The Caller ID or ANI may be a standard telephone number or other identifier (see definition for “telephone number”).

Destination: Also called “called party.” The person, business, or other destination that the caller wishes to be connected to is denoted as a “destination.” It may be a telephone (see “telephone” definition), or other equipment capable of taking calls.

Inbound call: From the caller's perspective, an inbound call is a call that the caller receives from another party, which may be, in the context of this invention, an inbound call from the callback system. (Note that an “inbound” call from the caller's perspective may be an outbound call from the callback system's viewpoint. For convenience, we generally use the terms “inbound” and “outbound” to refer to the call direction from the caller's, and occasionally the destination's, perspective.)

Network: The description of the current invention uses the term “network” to denote a telephone network, a wireless network, a data network, or other network capable of carrying voice traffic.

Outbound call: From the caller's perspective, an outbound call is a call that the caller dials.

Subscriber: A person, group, or organization that subscribes to a service, usually, in the context of this invention, to a callback service. The terms “caller” and “subscriber” are sometimes used interchangeably since a caller is often also a subscriber, but there is a distinction in some cases because the term “subscriber” implies that the caller has signed up and/or has an account with a service provider.

Telephone: This may be a classic analog (a.k.a. POTS, an acronym for Plain Old Telephone Service) telephone or other landline phone, digital phone, wireless phone, Wi-Fi (802.11 or similar) phone, Wi-Max phone, peer-to-peer phone, automated system, VoIP (Voice over Internet Protocol) phone, conference calling bridge, softphone (a voice or video phone comprised of software running on a computer, where the computer may be a desktop computer, laptop, PDA, cell phone, or other type of computer), video phone, or other device or system used for voice communication.

Telephone number: We use this term to denote an identifier used to specify a particular telephone (as defined above). The telephone number may be a digit string such as a telephone number, SIP (Session Initiated Protocol) address, IP address, user handle such as a moniker used in a peer-to-peer system, or other identifier that can be used to identify a telephone. A telephone number may also be a piece of information that can be mapped, using an account record or other database, to a telephone number. In the context of a user response, a telephone number may be spoken, dialed via DTMF, typed into a keyboard, entered via a mouse, or by other means of communicating information necessary to place a call.

In like manner, the terms “destination number,” “destination,” “callback number,” “caller's number,” “subscriber's number,” or sometimes just “number” are instances of telephone numbers as defined above and may also constitute various types of identifiers as described in the definition for “telephone number.”

T|S: Text-to-Speech (Synthesis).

VoIP: Voice over Internet Protocol, a collection of methods for sending voice communication over one or more data networks.

### DESCRIPTION OF FIGURES

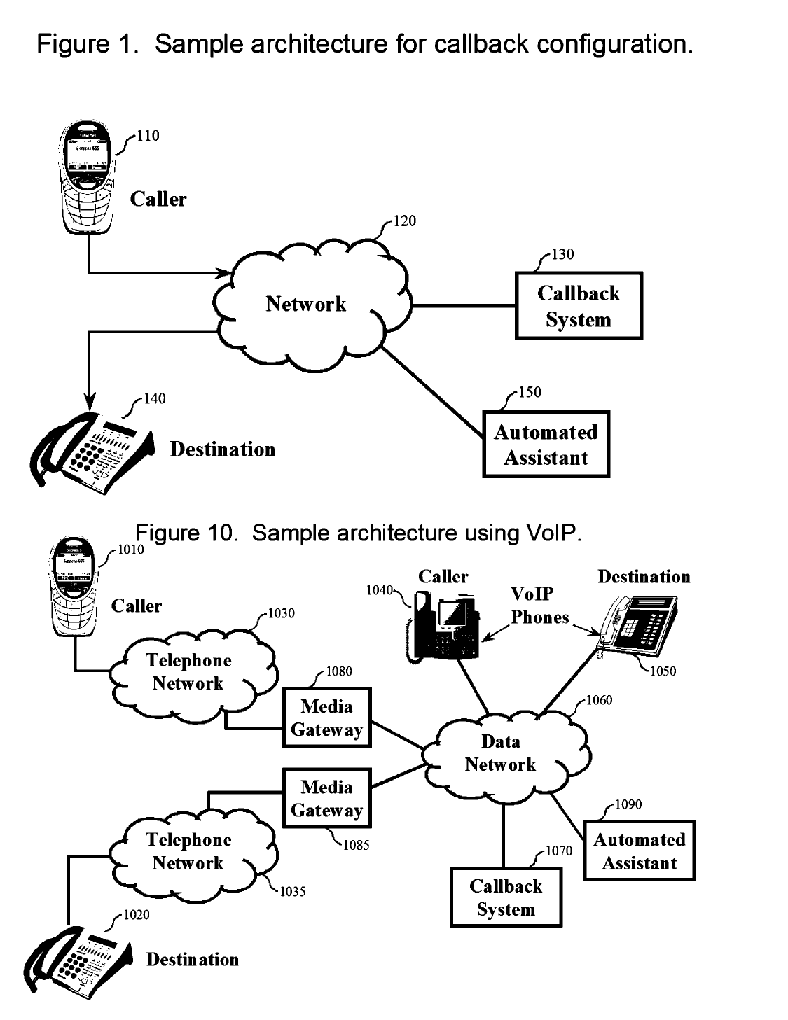

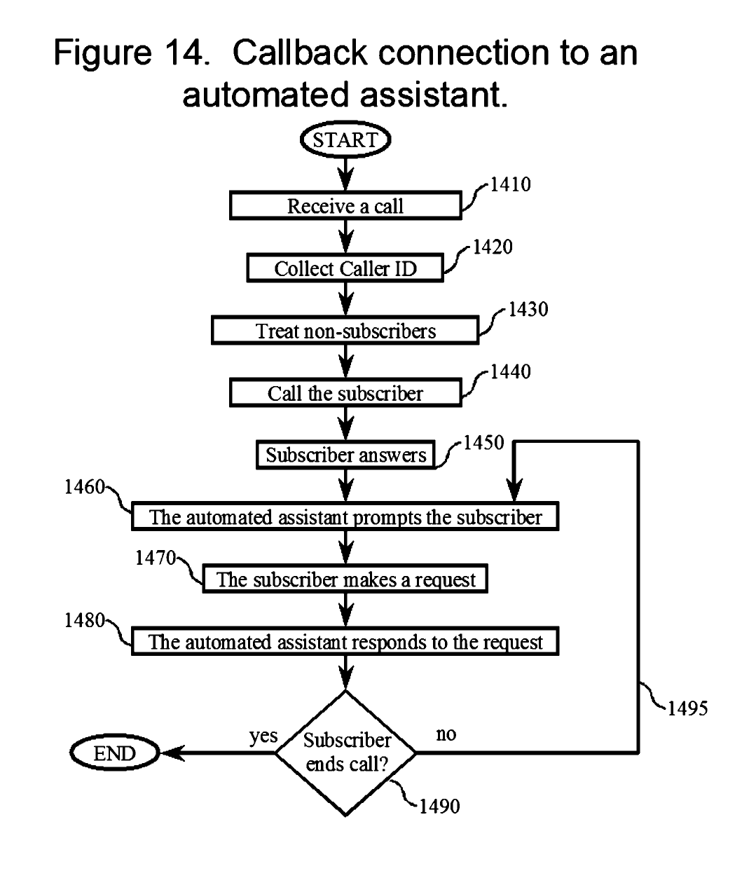

FIG. 1 shows a sample architecture for a callback system configuration. A caller uses telephone 110, shown illustratively as a cell phone, to place a call to callback system 130 via network 120. Callback system 130 detects an ANI for caller 110 and calls the caller back. Callback system 130 also places a call to destination 140, shown illustratively as a landline phone, and connects the two parties (i.e. sets up a voice path so that caller 110 and destination 140 can communicate). If telephones 110 and 140 have video capability, the callback system sets up a video path between the two phones. Block 150 may be ignored for the moment and is explained later (see the discussion on FIG. 14).

The callback system may be used for any type of phone—landline, mobile, VoIP, softphone, etc. (see the definition of “telephone” above). For economic reasons, certain phones are of particular interest:
(1) Landline phone service plans generally offer free inbound calling and there is no charge if the called party on an outbound call does not answer, so the callback service described is economically advantageous.
(2) Cell (a.k.a. mobile) phone service plans sometimes include unlimited inbound minutes, so the callback service may be seen as a means for converting metered outbound minutes to free inbound minutes.
(3) Inexpensive VoIP phone service plans sometimes offer unlimited inbound calling but limited outbound minutes, so a callback service is a means for placing outbound calls without using up outbound minutes.

An important component in enabling a service provider to build a viable callback service is cost. A callback service is likely to be an overlay service (a service provided in addition to a customer's basic telephone service), so the service provider may have difficulty attracting customers unless the callback service can offer calling at a lower rate than what a customer's basic service provider charges. In one embodiment of the current invention, the callback service uses a standard telephone network, i.e., Network 120 is a POTS or TDM telephone network. In a second embodiment of the current invention, costs are reduced by implementing the callback service in a packet network such as a VoIP or SIP arrangement.

An example of this second embodiment is shown in FIG. 10. Caller 1010 and destination 1020 are standard (non-packet) telephones on POTS or TDM telephone networks 1030 and 1035, respectively. Networks 1030 and 1035 may be different parts of the same network. Caller 1040 and destination 1050 are VoIP telephones connected, directly or indirectly, to data network 1060. Telephone network 1030 is bridged to data network 1060 by one or more media gateways 1080. Telephone network 1035 is bridged to data network 1060 by one or more media gateways 1085. Media gateways 1080 and 1085 convert analog or TDM signals to and from VoIP packets to that speech can travel between data network 1060 and telephone networks 1030 and 1035, respectively. The arrangement in FIG. 10 can reduce the cost of offering telephone service because bandwidth costs in data network 1060 are typically less than bandwidth costs in telephone networks 1030 and 1035. The value of a callback service with VoIP, shown illustratively in FIG. 10, is particularly advantageous if caller 1010 is geographically close to media gateway 1080 and destination 1020 is geographically close to media gateway 1085.

A callback scenario with the arrangement of FIG. 10 is illustrated using the following example: Caller 1010 places a call to callback system 1070. Since the callback system is reached via a local call or a toll-free number or is relatively short (on the order of a minute or less), the outbound portion of the call is inexpensive or possibly free. The outbound call begins at caller 1010, travels through telephone network 1030, media gateway 1080, data network 1060, and arrives at callback system 1070. The callback system collects caller 1010's ANI and other necessary information and the outbound portion of the call ends. A first inbound portion of the call begins with callback system placing a call to the ANI collected during the outbound portion. The inbound call then travels from callback system 1070 through data network 1060, media gateway 1080, telephone network 1030, and arrives at caller 1010. Caller 1010 answers and provides a destination telephone number (unless the destination identifier has already been provided). A second inbound portion of the call begins when the callback system places a call (or, in an unsupervised transfer model, transfers the first inbound call) to destination 1020 using the previously collected destination number. The second inbound (inbound from the destination's perspective) portion goes from callback system 1070 through data network 1060, through media gateway 1085, through telephone network 1035, and to destination 1020. Depending on the specific equipment used and the economics of the architecture options, the two inbound calls can be hairpinned or bridged together at callback system 1070, in data network 1060, in a media gateway (1080 or 1085), or even in the telephone network (1030 or 1035).

A similar scenario unfolds if a caller (in this example, caller 1040) and/or destination (destination 1050) uses a VoIP phone, except that now the phones are connected to data network 1060 instead of a telephone network so that no media gateway is needed.

Block 1090 is explained later in the discussion related to FIG. 14.

FIG. 10 and the associated description outline an example of how VoIP can be used to reduce costs in a callback service. It is to be understood that other configurations and sequences of events may be similarly used without departing from the spirit of the current invention. For example, rather than calling back the caller, collecting the destination number, and then calling the destination, the callback system might collect the destination number in the outbound portion of the call, then call the caller and destination simultaneously. In a second example, caller 1010 could call from a POTS network 1030 and the destination 1050 could be a SIP phone on a data network. In a third example, the caller could call from a VoIP phone 1040 and the destination could be a standard telephone 1020.

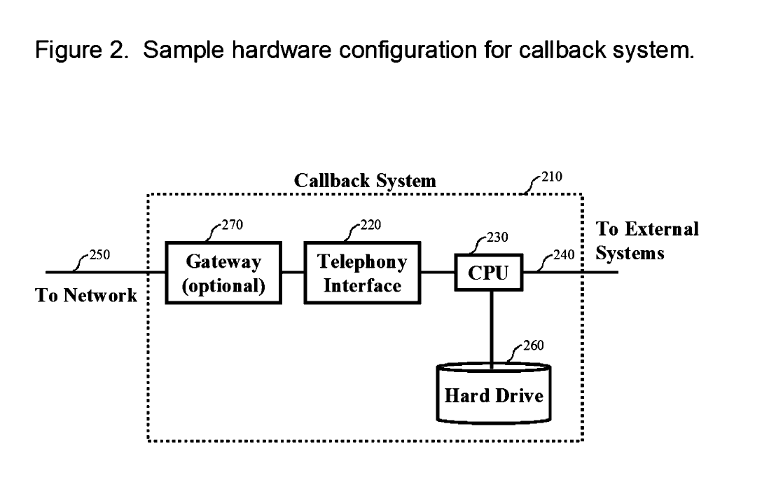

FIG. 2 shows an example hardware configuration for the callback system. A call arrives over network connection 250 to telephony interface 220. Telephony interface 220 is also used to place outbound calls and optionally to connect a caller to a destination. A computer, consisting of CPU 230, hard drive 260, and other components typically associated with a computer, illustrates a representative digital computer system that can be programmed to perform the method of this invention. Hard drive 260 contains software normally associated with a computer such as an operating system. Hard drive 260 also contains callback application software and possibly subscriber information such as subscriber ANI and account status. Hard drive 260 may also contain speech recognition software for understanding spoken input and/or text-to-speech software for providing instructions or announcing names. Subscriber information may also be stored in an external database, accessed by external connection 240. External connection 240 is an optional link to external systems such as directory assistance centers, external databases, and billing and subscriber account information systems.

Other digital computer system configurations can also be employed to perform the method of this invention, and to the extent that a particular system configuration is capable of performing the method of this invention, it is equivalent to the representative digital computer system of FIG. 2, and is within the scope and spirit of this invention. Once they are programmed to perform particular functions pursuant to instructions from program software that implements the method of this invention, such digital computer systems in effect become special-purpose computers particular to the method of this invention. The techniques necessary for this are well known to those skilled in the art of computer systems.

Optional gateway 270 serves as a protocol converter (from TDM (Time Division Multiplexing) or POTS to/from VoIP, for example) and/or a call concentrator/router. One purpose of the gateway (if used) is to more efficiently handle multiple simultaneous calls. Multiple calls may enter the gateway and be routed to an available telephony interface. Another purpose of the gateway is to bridge calls between the caller and the destination. Examples of a gateway that may be useful for this purpose are a PBX, a VoIP media converter, and a call distribution system.

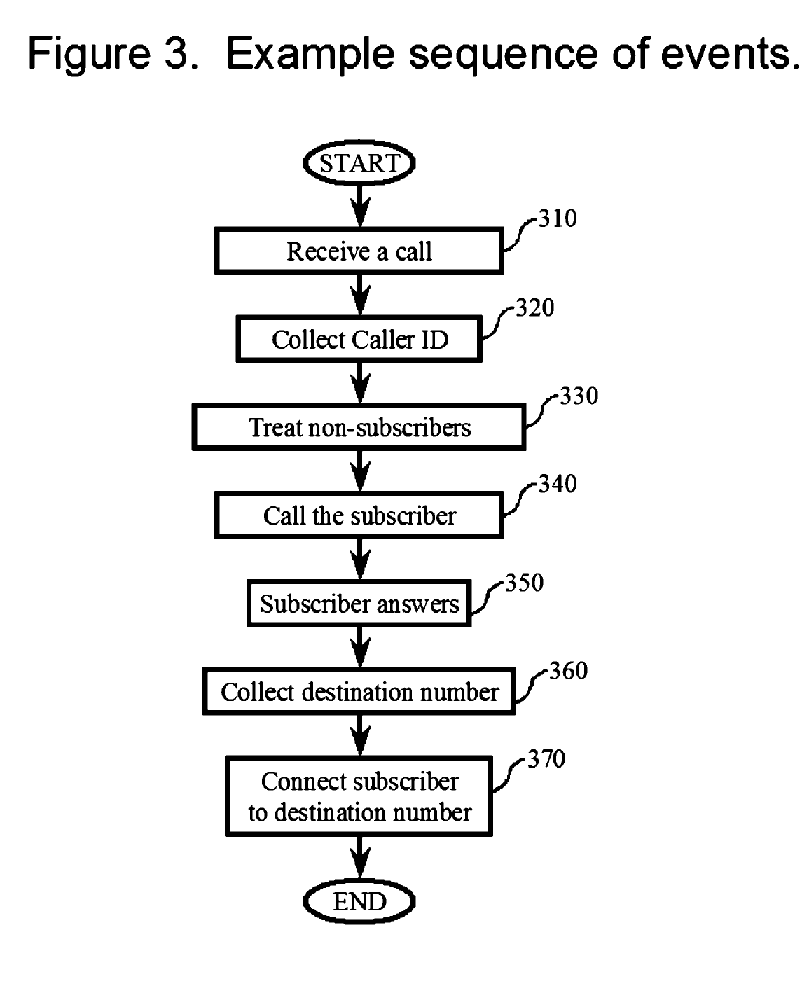

FIG. 3 shows an illustrative sequence of events in the callback invention. This sequence may be implemented in application code on disk drive 260 in FIG. 2. A call is received by the callback system in block 310. The callback system automatically (i.e. without requiring action on the part of the caller other than to place the call) collects the callers ANI (a.k.a. Caller ID) in block 320 using methods known in the art. In one embodiment of the current invention, the callback system does not answer the call, however, there are good reasons (described later) for answering the call in some circumstances, in which case the callback system terminates the call (i.e. hangs up) before beginning step 340.

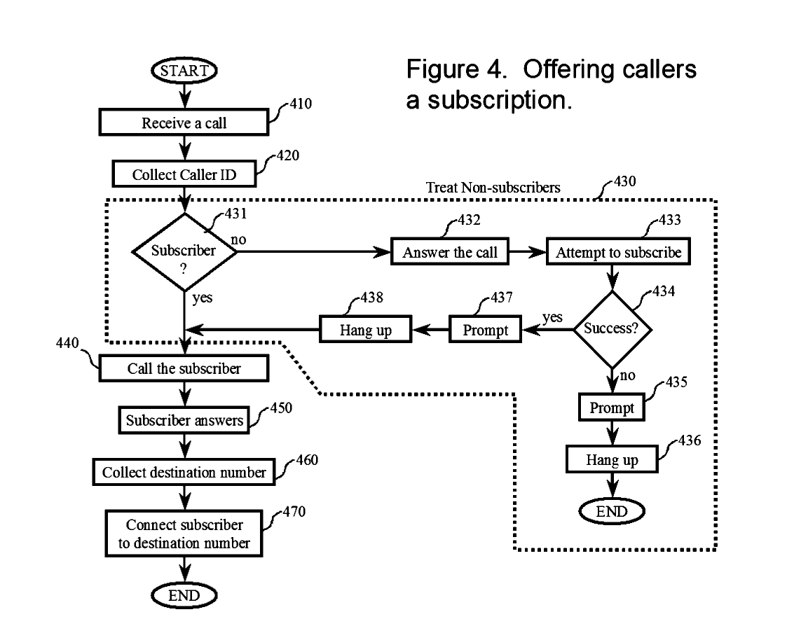

Block 330 checks the ANI to determine if the caller is a subscriber and tries to sign up the caller if not. See the description of block 430 in FIG. 4 for details.

In block 340, the callback system calls the caller back and the caller answers in block 350. It may require multiple tries to reach the caller, in which case block 340 may include the function of placing a call more than once if the caller is initially unreachable. For example, if the callback service calls the caller back before the caller has had time to hang up, the caller's number may ring busy, in which case it may be necessary to try again. Although we expect that the caller will answer in block 450, since the caller just called the callback service a few seconds ago, it is not guaranteed, so we make provision for the case where the caller is unreachable or fails to answer. In one embodiment of the current invention, the callback system terminates the call attempt. In an alternative embodiment, the callback system makes one or more repeat attempts to call the subscriber, up to a pre-determined number of tries, before giving up. Also, it may be useful, depending on caller behavior and network speed, to insert a small delay in block 340 before calling the subscriber to give the subscriber time to hang up and for the outbound call to be disconnected in the network.

The callback system collects a destination number from the caller in block 360. This collection step may consist of, for example (see definition of “telephone number” for details) prompting the caller to enter a DTMF number, speak a telephone number, type a telephone number (or other identifier) on a keyboard, speak a name associated with a telephone number, or enter or speak a speed dial sequence, and then collecting and converting the response to a telephone number or equivalent.

In one embodiment of the current invention, the destination is a telephone number, entered, for example, by DTMF or by voice. If by voice, a speech recognizer is used to identify the number. In a second embodiment of the current invention, the destination is a spoken name from a list of contacts in the caller's contact list. A speech recognizer is used to identify the name. In a third embodiment of the current invention, the destination is a telephone number or a spoken name. A speech recognizer that can understand both telephone numbers and spoken names determines what the caller says. In a fourth embodiment of the current invention, the destination is a name not in the caller's contact list, in which case the destination telephone number may be found in a public telephone listing or by connecting the caller or the callback service to a directory assistance service. Once the listing or directory assistance service finds the desired listing, the associated telephone number is used to determine the destination telephone number.

The collection step may optionally include greeting the caller by name. The callback system may, for example, say, “Hello, David. What number would you like to call?” (This name greeting step is optional because it has advantages and drawbacks. One advantage is that the caller knows that the system knows who he/she is and has the comfort of believing that the system is working properly. Another advantage is that greeting the caller by name adds a personal touch that the caller may appreciate. Disadvantages include potential higher cost and longer call times.) In one embodiment of the invention, the name is played as a pre-recorded file (created, for example, by a professional speaker) or using a text-to-speech synthesizer that uses the text of the caller's name as input. In a second embodiment of the invention, the caller is asked to say his/her name during enrollment, for example as part of block 433 in FIG. 4, and this recording is later played back to the caller as part of a greeting.

Block 370 connects the caller to the destination. This connection may be made in multiple ways, any of which are appropriate for the current invention, including:
(1) The caller may be connected to the destination using a blind transfer such as flash-hook transfer or SIP refer.
(2) The caller may be connected to the destination using a supervised transfer where an automated system or human operator monitors the status of the call attempt to the destination. If the destination answers and is not an answering machine, the call is transferred to the destination. If the destination is busy or otherwise unavailable, the callback service may take any of several actions (depending on how the service is sold, marketed, and billed), including connecting the call anyway, asking the caller for a different number, hanging up, playing an advertisement for another service, or allowing the caller to choose which action to take. If an answering machine (or, equivalently, a voicemail system) answers at the destination, then the callback service may still bridge the caller to destination or may go back to the caller for more options.
(3) The caller and destination may be “hairpinned” (meaning that the call remains connected to the callback system) instead of transferred. In a hairpin arrangement, the caller, destination, and callback system are connected on a three-way call. Hairpinning may use more resources, but may also allow more flexibility in handling the call. For example, if the destination hangs up, the callback system is still connected to the caller and may ask the caller for another destination number.
(4) The call may be bridged, then released to gateway 270, an external gateway, a conference service, or the network. In a release link, the voice traffic, instead of traveling through the telephony interface, may travel between the caller and destination via a gateway or directly through network 120 (FIG. 1).

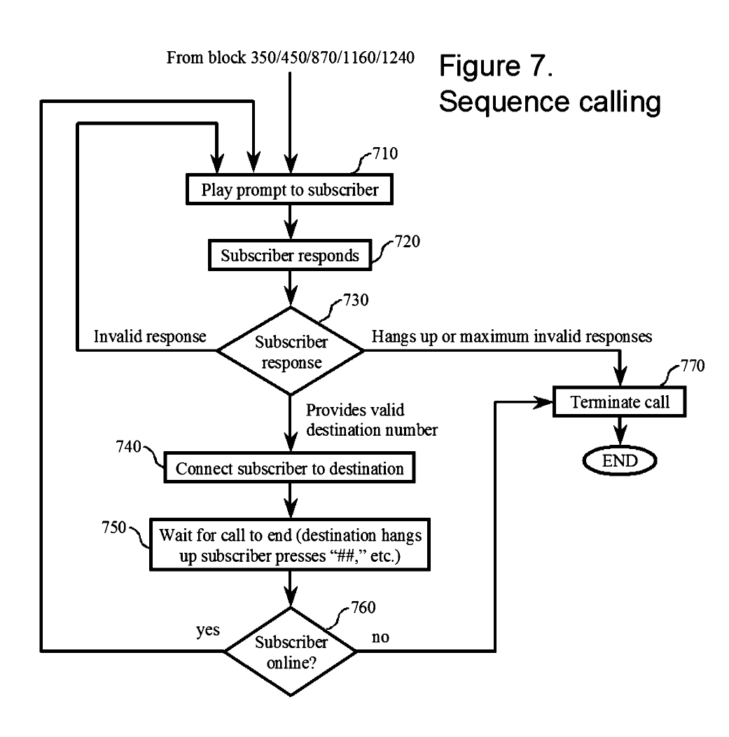

Depending on how the system is configured, the callback system may or may not retain control of the call once the call is released. The ability to retain control, and specifically to disconnect the destination and connect the caller to a new destination, is important for sequence calling (discussed below in the context of FIG. 7.) If the caller is only allowed to make a single call per callback event, then it generally doesn't matter whether or not the callback system retains control of a released call.

In one embodiment of the current invention, the subscription number and the service number are the same, so that callers can use a single number to subscribe to and to use the service. In a second embodiment of the current invention, the subscriber calls a first number to subscribe and is told using an announcement as part of the subscription of a second number to call to use the service. In a third embodiment of the current invention, a second number is given to the caller via email. In a fourth embodiment of the current invention, the second number is given to the caller via an SMS message to the caller's cell phone. In this fourth embodiment, the subscription service uses either the caller's cell phone number or an identifier provided by the caller to send an SMS message containing the second telephone number. An example of the fourth embodiment can be expressed in the following steps:
(1) A new subscriber calls a first telephone number to register his/her telephone number, name, and to complete the subscription. The subscription service collects the caller's ANI. If needed to send an SMS (in step 2), the subscription service asks for the name of the caller's mobile service provider.
(2) The system sends an SMS message to the number collected via ANI in step 1. The SMS message contains a second telephone number, that of a callback system.
(3) The subscriber dials the second telephone number and lets it ring one time, then hangs up. The subscriber's ANI is detected by the callback system and used in step 4 (next) to call the subscriber back.
(4) The callback system calls the subscriber's phone and invites the subscriber to say or dial a third telephone number.
(5) The subscriber provides a third telephone number.
(6) The callback system connects the subscriber to the third telephone number.

In a first embodiment of the current invention, if a local callback system number is provided to the subscriber, the number is chosen to be geographically close to the subscriber (so that the subscriber can minimize dialing charges) based on the subscriber's telephone number. There may be a single callback system number per billing area or there may be more than one. In a second embodiment of the current invention, the subscriber is given the option of choosing an area code and/or prefix. In a third embodiment of the current invention (and the second and third embodiments may both be used together), the subscriber is presented with a list of available numbers to choose from.

A callback service would be typically offered by a service provider. Since the motivation behind offering a callback service is usually to make money, it is useful to have some means of charging users. FIG. 4 shows additional detail regarding the case where we wish to charge the caller for the call, but the caller is not a subscriber. In the description, we refer to the callback system as the entity communicating with the caller, though the subscription tasks can equivalently be performed by a separate system designed to handle subscriptions. A call is received in block 410 and the ANI is detected in block 420. The ANI is then checked against a list of current subscribers in decision block 431. If the caller is a subscriber, the call proceeds with block 440 and continues as in the description for FIG. 3. If the caller is not a subscriber, the callback system (or an affiliated subscription system) answers the call in block 432 so that the callback system (or subscription system) may communicate with the caller.

If the caller is not a subscriber, the service provider has several options in block 433. The following are several solutions, all of which are valid in the context of the current invention, depending the business model preferred by the service provider. (1) The callback system informs the caller that the service is not available and hangs up. (2) The callback system plays an announcement that the service is only available to subscribers and then gives the caller instructions such as a web site address to visit or a telephone number to call. (3) The callback system asks the caller for a credit card number, a calling card number, or some other means of billing the call charges. (4) In the best mode of the current invention, if the caller is not a subscriber, the callback system attempts to sell the caller a subscription. The callback system answers the call in block 432 and offers a subscription in block 433. The subscription may consist of collecting billing information such as an address, running a credit check, collecting a credit card number, collecting a bank ABA number and account number, and/or giving the caller instructions for pre-paying for the service or for paying a security deposit. The collected billing information is thereafter associated with the caller's ANI so that the caller is treated as a subscriber in subsequent calls. A subscriber record is created that includes the new subscriber's telephone number or equivalent (gleaned from the ANI or Caller ID or from input from the caller) and the new subscriber's billing information. Other information may be collected from the caller and included in the subscriber record (and/or, as appropriate, included elsewhere), such as demographic information, the number the caller used to place the call, and answers to survey questions such as who the caller's service provider is and how much the caller spends on telephone service per month.

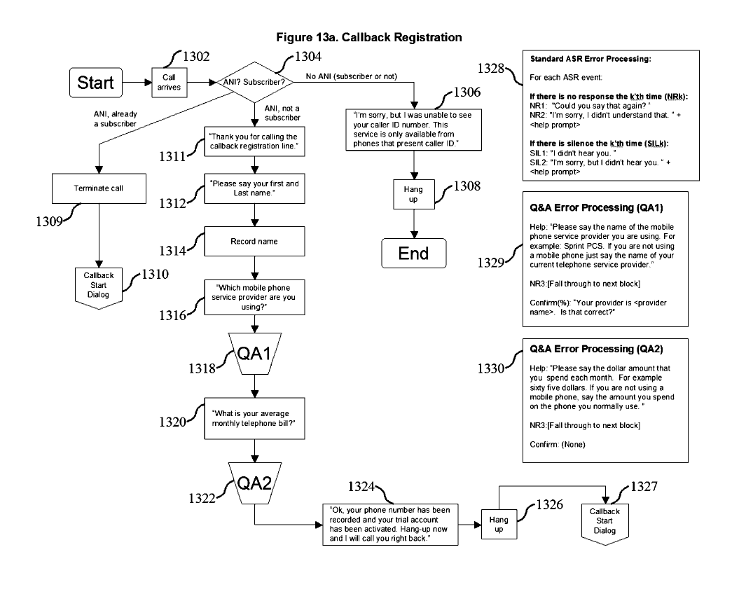

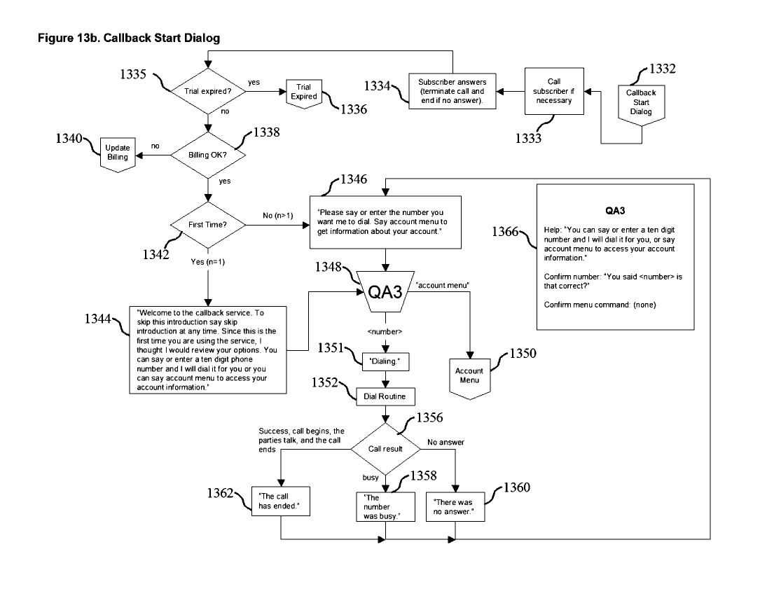

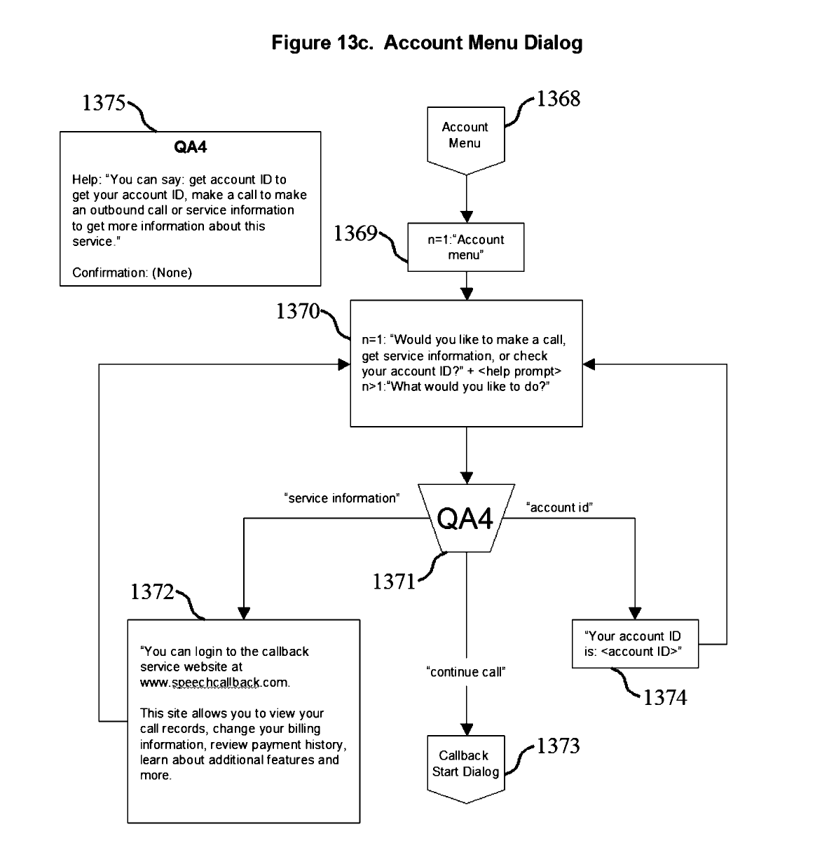

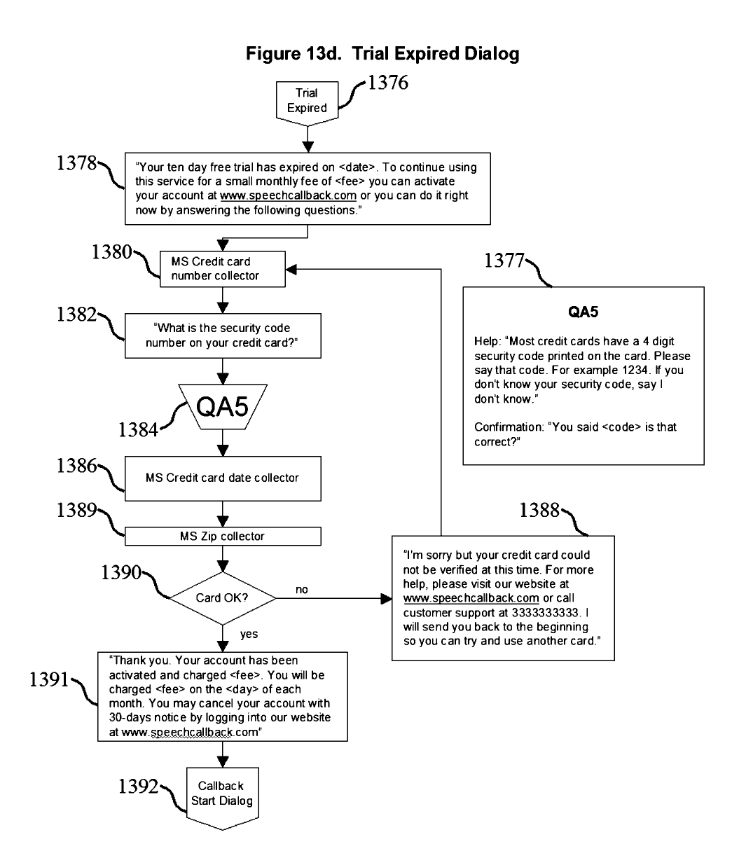

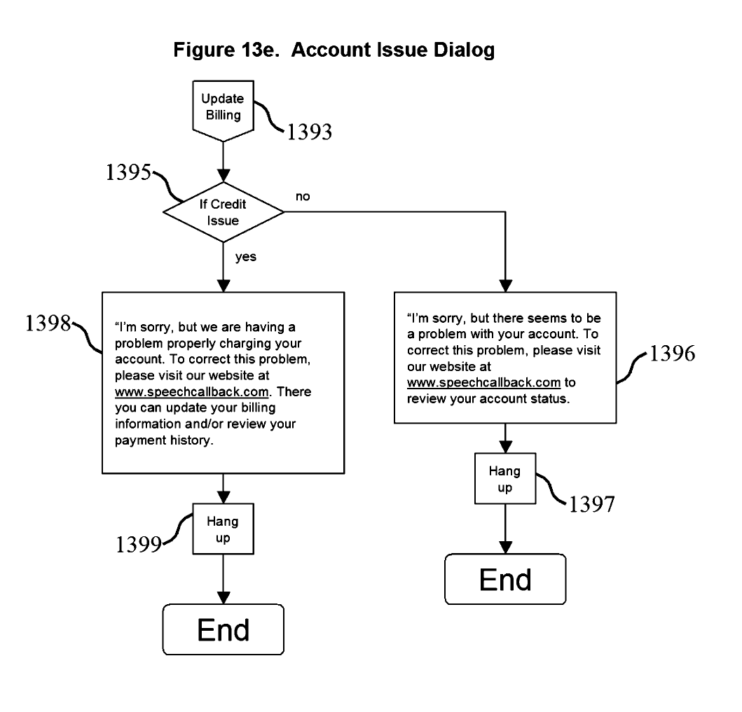

Note that there are many ways, of which the preceding are illustrative, to subscribe customers for a service, and it is understood that methods other than those detailed here may be used without departing from the spirit of the invention. For example, one way to win customers is to offer a free trial so that the prospective customer gets a chance to try the service for a period of time, but must pay for the service thereafter. One option for offering a trial before charging is shown later in FIG. 13.

The subscription process may also include asking the caller for information about the caller's current telephone service plan. This information may be used for marketing or other studies. The information may also be used to evaluate whether the caller is likely to save money using the callback service. If the answer is yes, this information may be provided to the caller as further inducement to sign up. If the answer is no, the caller may be advised that the service will not save him/her money. If the answer is no, the subscription process may include a step where the caller is offered a new service plan, such as one where the caller is likely to save more money with the callback service. For example, the callback system may offer to help the caller sign up for a new mobile phone service plan that offers free incoming minutes. This offer can be a source of revenue for the callback service provider, since said mobile phone service plan may be provided by a company that is willing to pay a referral fee for new customers. The caller may also be offered other additional services such as an account with a travel service or communication assistant 150/1090.

If the automated attempt to subscribe is unsuccessful, the caller may be connected to a live CSR (Customer Service Representative) who will attempt to sign up the caller. Alternatively, if the service provider feels that personal attention is warranted for all calls, the callback system may transfer the call directly to a CSR and skip the automated subscription attempt. The decision of whether to use a CSR either after or instead of an automated subscription attempt depends on the business model employed by the service provider.

Block 434 determines whether the subscription attempt was successful. If it was unsuccessful, the callback system plays a prompt in block 435 (for example, “Sorry. We are unable to offer you this service.”) to the caller and hangs up in block 436. If the caller was successfully subscribed, the callback system plays a welcome prompt in block 437 where the new subscriber is advised to hang up and the system will call back. The callback system then disconnects the call in block 438 and calls the new subscriber back in block 440. The call then proceeds as in the description for FIG. 3.

The section (block 430) of FIG. 4 inside the dotted line is represented elsewhere in this document (vis. block 330 in FIG. 3) as a block labeled “Treat Non-subscribers.”

If the service provider's business model does not provide for signing up callers in the manner shown in FIG. 4, then we delete blocks 433, 434, 437, and 438 and connect the output of answer block 432 directly to prompt block 435. The prompt may advise the caller that the caller's telephone does not have a subscription and provide instructions for signing up.

We can summarize one embodiment of the portion of the invention related to subscription in the following steps:
(1) A caller calls a first telephone number to reach a callback system.
(2) The callback system detects the ANI of the caller but does not answer the call.
(3) The callback system determines, based on the ANI, whether the caller is a current subscriber.
   If the caller is a current subscriber, the process continues at step 4, below.
   If the caller is not a current subscriber, the callback system attempts to sign up the caller with one or more of the following methods: i. Using an automated subscription system. ii. Connecting the caller to a live attendant. iii. Asking the caller to call a subscription number or visit a subscription website.
(4) The caller hangs up.
(5) The callback system calls the caller at a second telephone number determined from said ANI.
(6) The caller answers.
(7) The callback system collects a third telephone number from the caller to be used as a destination.
(8) The callback system connects the caller to said destination using said third telephone number.

An alternative embodiment of the invention is to ask potential subscribers to call a different number or visit a web site to sign up. An example of how this might work is shown in the following steps:
(1) A caller does one or more of the following:
   Visits a web site and signs up for a callback service.
   Calls a first telephone number and signs up using an automated system
   Calls a first telephone number and signs up with help from a live attendant.
   Receives a call from a live attendant or automated system and signs up during the call.
(2) A caller calls a second telephone number to reach a callback system.

The remainder of the process is as described in steps 2-8 in the previous list (except that in step 5, we refer to the caller's callback number as a third telephone number, and in step 7, we refer to the destination number as a fourth telephone number).

In one embodiment of the current invention, block 420 (or, equivalently, block 320) assumes that ANI is available for valid subscribers or subscription candidates. In this first embodiment, one destination number is shared among multiple subscribers. In a first example of the first embodiment, the callback system is reached by calling a local number, so that all callers in the geographical vicinity can call one or more local numbers. Since each local number is shared across multiple callers, the identity, and more importantly the callback number, of each caller may be unknown if Caller ID (or ANI) is not available. In a second example, callers use an 800 or other toll-free number, which is also shared across callers. These two examples show why Caller ID is useful in identifying callers. If ANI is not available, a prompt is played advising the caller that the service is only available for callers with Caller ID and the callback system then hangs up.

In a first alternative embodiment of the current invention, each caller is assigned a unique telephone number to call. This unique number may be a local number, long-distance number, or toll-free number. The callback system can then identify the caller by mapping the dialed number to the caller according to a database that relates assigned numbers to subscribers.

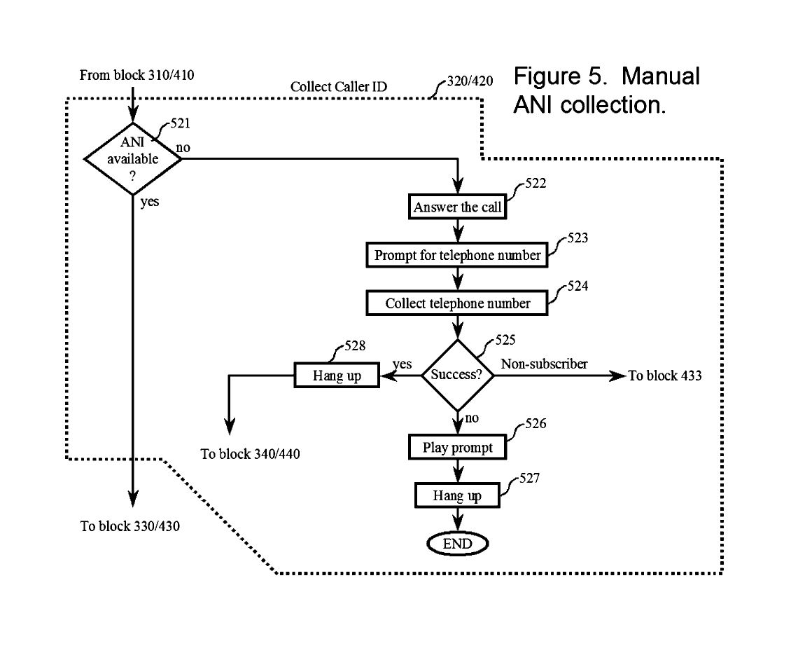

In a second alternative embodiment, the caller is given the option to enter his/her ANI manually. This embodiment is shown in FIG. 5, a detailed view of block 420 (equivalently, 320) for the case where the service provider wishes to allow callers to enter their callback number when ANI is not available. Decision block 521 tests whether ANI is available. If ANI is available, control proceeds to block 330/430 as in the descriptions of FIGS. 3 and 4.

If ANI is not available from the network, an attempt is made to collect it from the caller. The callback system answers the call in block 522 and prompts the caller in block 523. In one embodiment of the current invention, the prompt asks for a telephone number (or equivalent identifier—see definition of “telephone number”). Depending on what equipment (VoIP vs. POTS, etc.) is available, the prompt may ask for a specific type of telephone number (or equivalent). If a speech recognizer is available, the announcement may prompt the caller to speak the information; otherwise the announcement will invite the caller to press the appropriate digits on a telephone or type relevant information into a keyboard, as appropriate. In an alternative embodiment, instead of asking for a telephone number, the callback system asks the caller for another piece of information that can be mapped to a telephone number such as a credit card number, name, company extension, or account number, and said other piece of information is then mapped to a telephone number (or equivalent) using a directory listing, account record, or other database.

Block 524 collects the telephone number provided by the caller using a speech recognizer, DTMF detector, or other detector corresponding to the type of input requested in prompt 523. Not shown in FIG. 5, but according to standard user interface practices known in the art, it may be appropriate to repeat blocks 523 and 524, possibly with some variation, to reprompt the caller if an error is detected.

Block 525 determines whether a valid telephone number was collected. If a valid telephone number was not collected, the callback system plays a prompt to the caller in block 526 and hangs up in block 527. If a valid telephone number was collected, it is then used in place of an automatically detected ANI by block 330/430.

At this point, the simplicity of our description is spoiled by the fact that the call has been answered, yet block 330/430 is next to be executed and may potentially answer the phone again. For this reason, control cannot necessarily pass from block 525 or 528 to blocks 330/430 in FIGS. 3 and 4. It is clearly not possible to answer the phone twice, so some careful scripting is required to get around this awkward logical paradox. Devising an appropriate solution is a simple matter for computer programmers who are trained to sort out such ugliness. The example solution shown in FIG. 5 is as follows: In addition to determining whether a valid ANI was collected, block 525 performs an additional test on the collected ANI to match it against a subscriber list. If ANI is collected, but does not correspond to a current subscriber, control is transferred to block 433, effectively bypassing hang-up block 528, decision block 431, and answer block 432 (these three blocks are unnecessary in this case). If ANI is collected and corresponds to a current subscriber, the callback system hangs up in block 528 and transfers control to block 440 (equivalently, block 340), thus bypassing block 330/430 altogether.

In a first embodiment of the current invention, the callback number and the subscriber's account number are the same. Both numbers will be the same if the subscriber's ANI is used to subscribe and the subscriber is reached via the same number as the subscription number. In a second embodiment, when ANI is not detected, the subscriber is asked for the account number (nominally a telephone number such as the one that would have appeared with Caller ID) listed in the subscriber's account (essentially treating the telephone number as an account number). The callback system then asks the subscriber for the callback number. The callback number may be different from the account number if, for example, the subscriber signed up at home but wishes to use the service from work. Note that in this second embodiment, if ANI is detected, the callback system may deny service if the Caller ID number is not listed as a current subscriber. This could cause problems, if, for example, a caller subscribed at home and wishes to use the service at work, but the callback server is able to recognize the work ANI and the work ANI is not listed as belonging to a subscriber. This potential problem is remedied in a third embodiment where the caller is asked to provide an account number and a callback number even if ANI is available. (The account number may optionally be omitted if the ANI is available and matches a subscriber's ANI). The callback service uses the provided account number to verify that the subscriber has a valid account and the provided callback number to call the subscriber back. In a fourth embodiment, subscribers are able to list more than one number in their account record so that callers are recognized and called back if they call from any of the numbers in the record. For example, a subscriber may provide a home, work, and mobile phone number in the subscription process so that if the subscriber calls from any of these three numbers, the callback system will verify that the caller is a subscriber and will call the subscriber back at the same number as the subscriber just used to call the callback system.

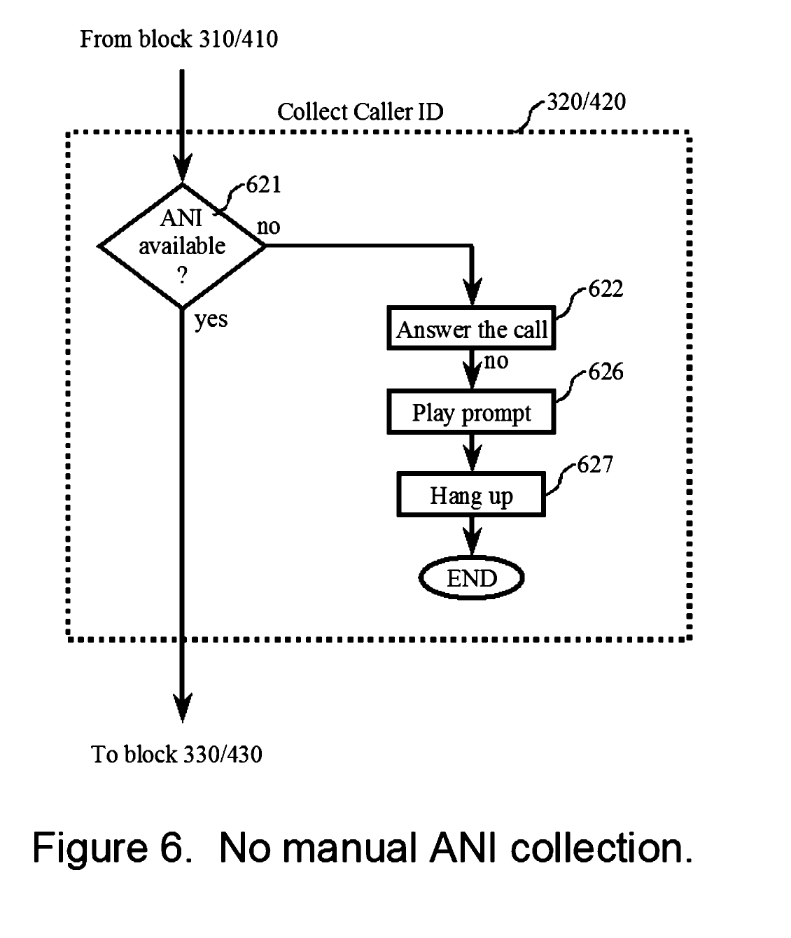

Note that the elements of FIG. 5 are optional, depending on whether the service provider wishes to allow callers to enter a callback number manually. If the service provider wishes to only allow automatically collected ANI, then the “Collect Caller ID” block (320/420) is reduced to the form shown in FIG. 6. Decision block 621 determines whether ANI is available. If ANI is available, control passes to the next block, 330 or 430, in FIG. 3 or 4, respectively. If ANI is not available, block 622 answers the call, block 626 gives the caller the bad news, and block 627 disconnects the call.

In one embodiment of the current invention, the callback system allows the subscriber to place a single call per callback event. (A callback event is a single instance of the callback system calling the subscriber.) This embodiment is shown in FIGS. 3 and 4. If the subscriber wishes to place a second call, he/she must call the callback system again, hang up, etc., to repeat the same process as for making the first call. In an alternative embodiment, shown in the example of FIG. 7, the callback system allows sequence calling so that the caller may remain on the line and place multiple calls per callback event. Blocks in FIG. 7 take the place of blocks 460 and 470 in FIG. 4 (equivalently, blocks 360 and 370 in FIG. 3).

The steps in FIG. 7 begin after the callback system has called the subscriber and the subscriber answers (after blocks 350 and 450 in FIGS. 3 and 4, respectively, and others that will be discussed below). Block 710 plays a prompt to the subscriber, asking him/her to provide a destination. A destination can be any form of telephone number (such as a digit string) or a piece of information (such as a spoken name) that can be mapped to a telephone number (see the definition of telephone number). If the destination is in a spoken form such as a name from a name dialing list or a spoken telephone number, a speech recognizer is used to identify the spoken result. The subscriber responds in block 720 and the response is evaluated in decision block 730. A valid response is one which provides the information requested by prompt 710. If the response is invalid (i.e. is not a destination or a response that can be mapped to a destination), then the subscriber is reprompted until the response is valid or up to a predetermined number of times by looping through blocks 710, 720, and 730. If the loop count exceeds a predetermined limit (two attempts is about right), control transfers to block 770 where the call is terminated (optionally with a farewell prompt). If the subscriber hangs up or the line is otherwise disconnected, the call also ends via block 770. If, on the first or any subsequent retry, the subscriber response is valid, the subscriber is connected to the destination in block 740. The connection remains until the call ends in block 750. Any number of events can end the call—either party can hang up, the system can terminate the call because the subscriber's account is out of minutes or a bill is overdue, one party or the other may press a sequence of buttons or speak a code word to end the call, etc. Typical events that would allow a sequence call (defined as a call where subscriber can talk to multiple parties in sequence without hanging up in between) are that the destination hangs up or the subscriber presses “##,” a common DTMF sequence used to disconnect a call. If, after the call ends, the subscriber is still online, as determined by decision block 760, the subscriber is prompted for a new destination and may place another call. If the subscriber is not online (e.g. if the subscriber hangs up), the call ends via block 770.

In one embodiment of the current invention, decision block 760 only considers whether the subscriber is online. In an alternate embodiment, the decision block first determines whether the subscriber is online (and if not, ends the call), then asks the subscriber if he/she wishes to place another call and prompts for a response (voice, DTMF, etc.). If the response is affirmative, the subscriber is prompted for a new destination in block 710, otherwise the call ends via block 770.

In the embodiment of the current invention shown in FIGS. 3 and 4, the callback system does not answer the caller's call and does not prompt for the destination number until the callback (inbound) portion of the call. In an alternative embodiment, which we call “early number collection,” the callback system does answer the caller's call and prompts for the destination number in the first part of the call (the outbound portion). This alternative may have a drawback in that the caller may be charged for the outbound portion of the call if the callback system answers. (With some calling plans, particularly for cell phones, the caller is charged whether or not the called party answers, so this drawback may not be relevant.) Another possible drawback is that the destination collection phase may extend the time of the outbound portion of the call. An advantage of early number collection is that it is possible to reduce the amount of time it takes to place a call because the caller and destination may be called simultaneously.

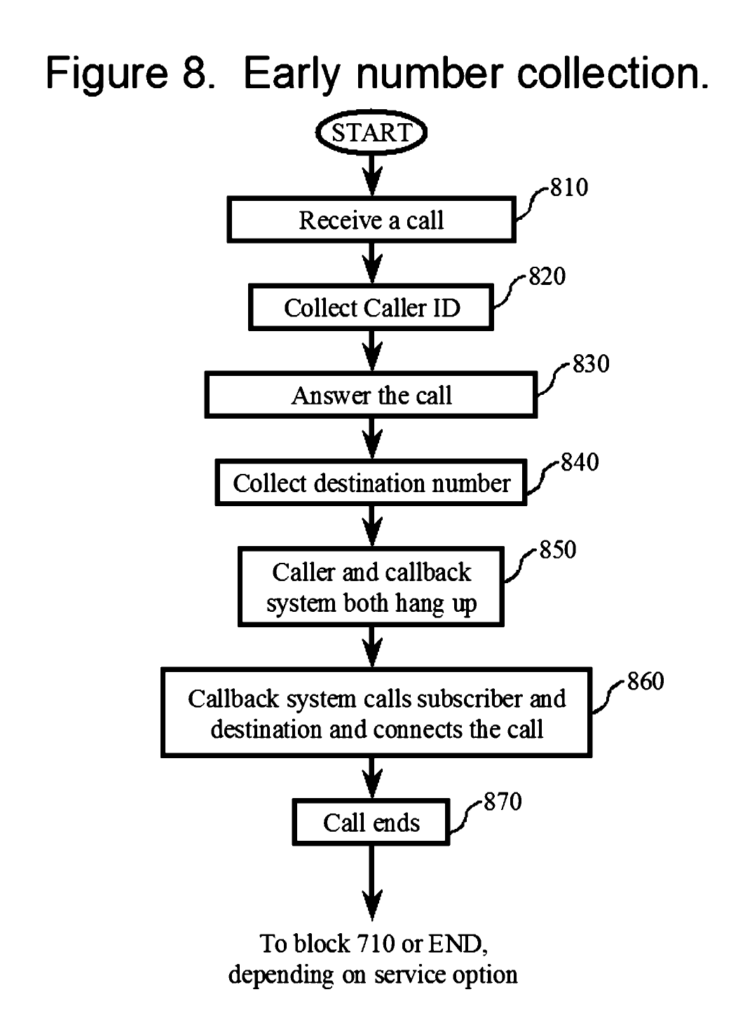

FIG. 8 illustrates an example of early number collection. The callback system receives a call in block 810 and collects the ANI in block 820. Unlike in previous examples, the callback system now answers the call in block 830 and collects a destination number in block 840. The caller and callback system then disconnect in block 850. The callback system calls the caller (subscriber) and the destination in block 860. If network delay and/or slow caller response result in the line being busy when the callback system calls back, it may be useful to allow multiple call attempts to the caller and/or to add a brief delay before calling the caller in block 860. When the call ends in block 870 and if the subscriber does not have a sequence dialing feature the callback system ends the call. If sequence dialing is active, the subscriber is prompted for a new phone number in block 710 of FIG. 7 and the call proceeds from this point as described in relation to FIG. 7, i.e. the sequence calling portion of the call in early number collection is the same as without early number collection.

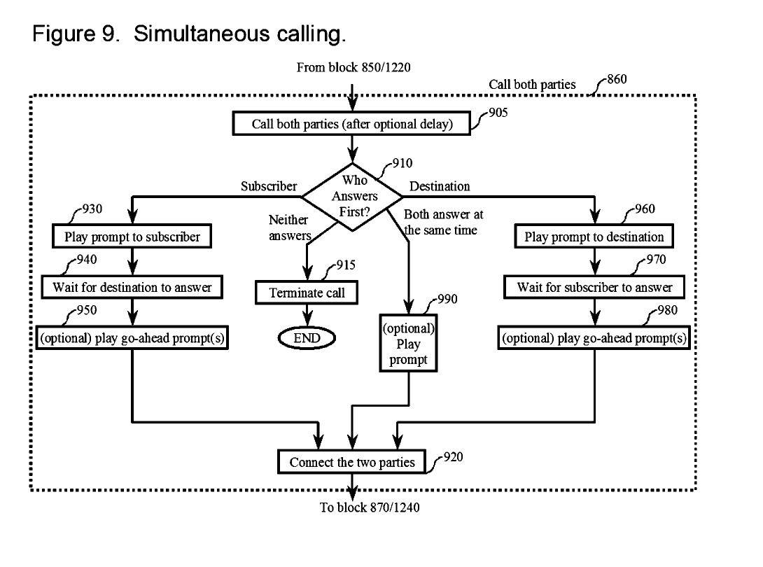

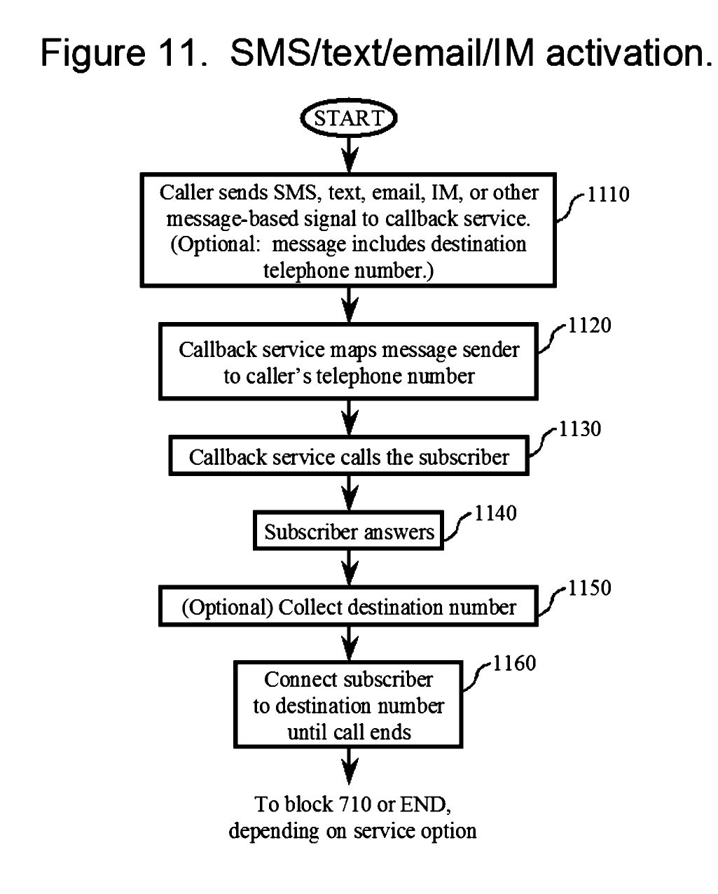

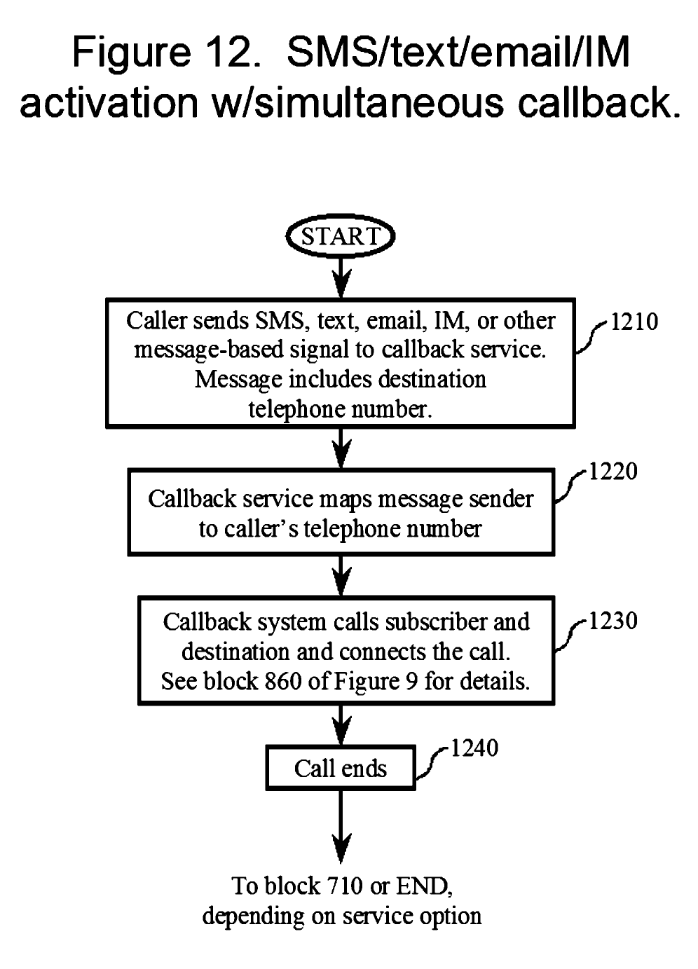

In one embodiment of the invention, in block 860 of FIG. 8, the callback system calls the subscriber, waits for an answer, then calls the destination and connects the call. In an alternative embodiment of the invention, which may be faster but entails some complexity, the callback system calls the subscriber and destination at the same time in block 860. In this alternative embodiment, there is a possibility that one party may answer a few seconds or more before the other party, potentially causing some confusion. This potential confusion is minimized by monitoring which party answers first and playing waiting prompts as necessary as shown in FIG. 9.

FIG. 9 is a detailed view of block 860 where both parties are called simultaneously. In block 905, the caller (subscriber) and destination are both called at about the same time. To avoid the caller's number being busy or to attempt to arrange for both parties to answer their respective phones at about the same time or in a logical sequence, it may be useful to call each party after a brief delay. For example, if the callback server waits 5 seconds before calling the subscriber, there is a smaller likelihood that the caller's line will still be busy from the outbound portion of the call. If another 5-second delay is inserted before calling the destination, there is a greater likelihood that the caller will be on the line when the destination answers. (Since the subscriber is placing the call, he/she knows what to expect, so there is some advantage to having him/her on the line when the destination answers.) These delay times (5 seconds and 5 seconds) are illustrative.

Once both parties are called, a determination is made in decision block 910 as to which party answers first. Matters are simple if both answer at or nearly at the same time—the two parties are connected in block 920 and may talk to each other. To be sure both the caller and the destination know what is happening, it may be useful for the callback system to play a prompt to one or both parties in blocks 950, 980, and 990. The prompt may be simply, “Go ahead please,” or “You will be connected now,” for example. If neither party answers, the call ends via block 915.

If the subscriber answers first, the callback system plays a prompt in block 930 to the subscriber to let him/her know that the system is placing the call he/she requested and that the destination has not yet answered. The prompt may be generic (i.e. “the person you called has not yet answered”) or personalized (i.e. “waiting for David Thomson to answer” or “The number 630-852-3537 is ringing”). The prompt may also be non-verbal, such as one or more beeps or a ringing tone. The prompt may be an advertisement or a combination of all of the above. The prompt may even be silence (equivalent to skipping steps 930 and/or 960).

The subscriber waits for the destination to answer in block 940. After the prompt in block 930 plays, or even while the prompt is still playing, if the destination answers, the subscriber and/or the destination hear a prompt in block 950 and are then connected in block 920. The subscriber and destination need not necessarily hear the same prompt in block 920. For example, the subscriber may hear, “Your party has answered. Go ahead, please.” while the destination hears, “You have a call from John Smith. You may speak now.”

Blocks 960-980 function essentially the same as blocks 930-950, swapping the subscriber and destination. If the destination answers first at decision block 910, the destination hears a prompt in block 960 and the destination waits for the subscriber to answer in block 970. Once the subscriber answers, optional prompts play in block 980 and the parties are connected in block 920. Prompts in different blocks need not be the same and may even be different for the subscriber and destination. For example, in block 960, the destination may hear, “John Smith is calling you. Please hold.” while block 930 plays “Please wait for your party to answer.” Note that in cases where a name is played, it may be impractical to use recorded prompts and may be more convenient to use a text-to-speech sythesizer to pronounce the names.

In the embodiment shown in FIG. 9, the subscriber and/or destination may wait indefinitely for the other to answer. In practice, it may be useful to implement an alternate embodiment with a timeout so that in block 970 the destination is ultimately asked to hang up and/or, in the case of the subscriber waiting, in block 940 the subscriber is eventually given the option of hanging up or trying another destination.

Two error conditions not shown in FIG. 9 are: (1) the subscriber is unreachable or the line is busy. In this case, the subscriber and destination calls are terminated. Alternately, if the service plan so dictates, the subscriber line is tried periodically until it is answered and the destination is then called, at which point operation continues with block 930. (2) the destination is unreachable or the line is busy. In this case, the destination call is dropped and the subscriber is apprised of the result via an announcement. If the service plan so dictates, the destination line is tried periodically until the original error condition clears (for example, if the line was busy, a ringing signal clears the error condition), then the subscriber is called and operation proceeds with block 910.

Although parts of the preceding description uses an outbound call from the caller to initiate the callback event, other trigger options exist. All that is necessary is for the caller to signal to the callback system to request an inbound call. There are many ways this signal may be sent, of which an outbound call is only one. This signal contains the caller's telephone number or other piece of information that can be mapped to the caller's telephone number. (For consistency, we may still refer to the person initiating the call as a “caller,” even though, in a message-based option, the “caller” may not actually place a phone call, rather the “caller” sends a message instead.) This signal optionally (depending on how the service provider wishes to deploy the callback service) also contains the destination telephone number or other piece of information that can be mapped to the caller's telephone number.

In one embodiment of the current invention, an outbound call from the caller initiates the callback event. In an alternative embodiment of the current invention, a message is sent to the callback system instead of an outbound call. FIG. 11 illustrates such a message-based callback service. In block 1110, the caller sends a message to the callback service. The message may be an SMS message, an email message, a text message, an IM (Instant Messaging) message, or another message containing some information about the caller. The information must include some information about the caller so that the callback service may then place a call to the caller. This information may be in the message header (usually sent automatically) or in the body (the portion of the message determined by the caller). The message may automatically include the identity of the sender as part of the header information. This identity may be a phone number, in which case the callback service (block 1120) may use this phone number to call the subscriber back. The identity may alternatively be another form of information about the caller such as an email address or other account number, in which case the callback service checks the caller's account record or customer profile to map the information received to the caller's telephone number in block 1120.

Once the callback service receives the caller's message, it calls the caller in block 1130 via the received telephone number (or via information from a database based on other information received from the caller). Once the caller answers in block 1140, the callback service prompts the caller in block 1150 for a destination telephone number and collects the result. If the callback service already has the destination, for example, if the destination telephone number or equivalent was provided in the original message from the caller (and FIG. 12 goes into more detail on this possibility), then the callback service may skip block 1150. The callback service then calls the destination and connects the caller to the destination in block 1160.

Once the call ends and block 1160 is finished, the callback service either disconnects, or if the subscriber is offered sequence calling, the callback system prompts the subscriber for another destination telephone number and the call continues as shown in FIG. 7, starting with block 710.

The caller may be required to manually enter certain information into the message body. If the caller's telephone number (or other information that can be mapped to a telephone number) is not automatically sent with the message or the message header, the caller may need to enter a telephone number or equivalent into the message body so that the callback service will know where to reach the caller.

Note that the message system need not necessarily be the same equipment as the caller's telephone. For example, the caller may use a laptop to send an email to the callback system, but receive the inbound call on a cell phone. Of course, in some cases it is convenient for the message system to be the same as the telephone. For example, if a caller sends an SMS from a cell phone, the cell phone telephone number will likely be transmitted along with the SMS message so the caller's telephone number will automatically be available to the callback system for use in calling the caller back. Either way, the callback system has access to the caller's account information, profile information, or other information useful for mapping information received from the caller's message to the caller's telephone number.

As shown in block 1110, the service provider may wish to allow, or even require, the caller to include the destination number (in some form such as a name or other information that can be mapped to a destination number) as part of the message. In this case, the method shown in FIG. 11 provides for skipping the destination collection after the subscriber is called by skipping block 1150. In one embodiment of the current invention, the method shown in FIG. 11 is used to use a destination number sent by the caller in the original outbound message to call the destination. In an alternative embodiment, the caller and destination are called simultaneously as shown in FIG. 12. The caller sends an SMS, text, email, IM or other message to the callback system in block 1210 and includes the destination number or equivalent. In block 1220, the callback system looks up the caller's telephone number from the message header or body and also reads the destination telephone number from the message. In block 1230, the callback system calls the caller and the destination at approximately the same time. An example of how this simultaneous calling may be performed is shown in FIG. 9 and the description related to FIG. 9.

FIG. 13 details the call flow for a complete callback service. While this example does not include all optional capabilities, it may be considered a best mode in the sense that it is illustrates an entire call flow, includes error conditions, and gives sample wording for prompts. The figure is divided across five pages labeled FIG. 13a, FIG. 13b, FIG. 13c, FIG. 13d, and FIG. 13e.

Block 1328 specifies processing for ASR error conditions and applies to all five pages of FIG. 13. If there is energy, suggesting that the caller spoke, but there is no recognizable response (NR1), the system asks, “Could you say that again?” If there energy the second time but there is still no valid response (NR2), the system says, “I'm sorry, I didn't understand that,” then plays a help prompt. If there is silence (suggesting the caller said nothing), the system says, “I didn't hear you” the first time (SIL1) and “I'm sorry, but I didn't hear you” with a help prompt the second time (SIL2).

The application begins in FIG. 13a with block 1302 where the call from the caller arrives. Block 1304 determines whether Caller ID (a.k.a. ANI) is available. If ANI is not available, block 1306 plays an announcement to inform the caller that the service is not available and why. The callback system then hangs up in block 1308.

If ANI is available and the caller is not already a subscriber, the callback system signs up the caller for a trial account starting in block 1311. In the current example the trial period is free, though we could envision a similar method used for selling a full-priced account, offering a reduced-rate trial period, offering free service for signing up a friend, or offering other types of incentives. Not shown in FIG. 13 is a check using the caller's ANI to insure that the caller has not already signed up for a free trial. If the caller is attempting to sign up for another free trial, the trial may be denied, the terms may be changed, or the caller may be connected to a live agent. Free trials may be limited by one or more of the following constraints: a maximum number of calendar days, a maximum number of calling minutes, a maximum single call duration, and/or geographical calling restrictions.

If ANI is available, block 1311 welcomes the caller and block 1312 asks the caller for his/her name. In block 1314, the caller's spoken response is recorded for future use, for example to be able to later greet the caller by name. The service then asks survey questions, advantageously two questions in this example. The first question is asked in block 1316 and the response is captured in the question and answer block 1318 labeled “QAI.” The spoken result of the caller is stored, either as an audio file or, after a speech recognizer is used to interpret the result, as text in a text file or other database.

Note 1329 specifies actions for handling certain error conditions in QAI (block 1318) as follows: If the caller says, “help,” then the announcement, “Please say the name of the mobile phone service provider you are using. For example: Sprint PCS. If you are not using a mobile phone just say the name of your current telephone service provider.” is played as shown. If there is no recognized response in the first or second attempt, action specified in block 1328 applies. If there is no recognized response in the third attempt (NR3), the application continues to the next block (1320). Note 1329 also specifies a confirmation prompt, “Your provider is <provider name>. Is that correct?” (The term “<provider name>” is replaced with the recognized name that the ASR software determines was spoken by the caller.) Standard industry practices are used in the confirmation stage, meaning that, for example, if the caller answers “yes,” processing continues and if the caller answers “no,” the system makes one or more additional attempts, as appropriate, to collect the information. Other notes in FIG. 13 (notes 1330,1366,1375, and 1377) use similar standard error handling and confirmation methods as that shown in note 1329.

A second survey question is asked in block 1320 and the result is collected in QA2 (block 1322). Error processing for QA2 is specified in note 1330 and is similar to error processing for QAI except that no confirmation is performed. Block 1324 gives the caller, now a subscriber, further information and instructions, including the directive to hang up so the callback system can call the subscriber back. The system hangs up in block 1326 and control is transferred to the Callback Start Dialog as shown by transfer block 1327.

If decision block 1304 determines that ANI is available and that the caller is already a subscriber, the callback system does not answer the call, rather it disconnects (if the call was connected) in block 1309, and goes directly to the Callback Start Dialog (FIG. 13b) as shown by transfer block 1310.

Unless decision block 1304 determines that no ANI is available and ends the call via blocks 1306 and 1308 (and barring certain error conditions), the result of the steps in FIG. 13a is to execute Callback Start Dialog, shown in FIG. 13b. The start of the diagram is shown by block 1332 and the first action is to call the subscriber, if necessary, in block 1333. We specify “if necessary” because in some cases, such as the Account Menu Dialog shown in FIG. 13c, the caller is already on the line. If control originates from one of the blocks in FIG. 13a, it is necessary to call the subscriber.

The subscriber answers, hopefully, in block 1334. If there is no answer because the line is busy, unreachable, or is not answered, the call attempt is dropped and execution for this particular caller ends. If the caller answers, decision block 1335 checks to see if the caller's trial period has expired. In the example here, the trial period is 10 days. If the trial period has expired, the path to transfer block 1336 is taken to the “Trial Expired” dialog (FIG. 13d ). If the trial period has not expired, block 1338 tests whether the customer's account is in good standing. The account is in good standing if it is paid up or if the customer can be billed using available billing information. If the account is not in good standing, control transfers via block 1340 to the “Update Billing” section, shown in FIG. 13d. If the account is in good standing, block 1342 determines whether this is the subscriber's first call (since subscribing). If this is the first call (n=1), the long prompt in block 1344 is played to the subscriber. If this is not the first call (n>1), the short prompt in block 1346 is played to the subscriber. Whether announcement 1344 or 1346 is played, QA3 block 1348 determines whether the subscriber says “account menu” or a telephone number.

If block 1348 determines that the caller said “account menu,” control goes via block 1350 to the “Account Menu” section of the application, shown in FIG. 13c. Note 1366 defines exception handling for block 1348 (QA3). If the caller says, “help,” the help announcement is played. The phrase “account menu” is accepted if recognized and is not confirmed. If block 1348 determines that the subscriber spoke a telephone number, the system confirms the number as shown in note 1366. If the subscriber dials a telephone number, no confirmation is necessary. If a telephone number dialed, or spoken and confirmed, block 1351 plays a dialing announcement and block 1352 dials the number.

The call may have one of several outcomes as determined by decision block 1356. The number may be busy, in which case announcement 1358 is played. There may be no answer, in which case announcement 1360 is played. The number may be answered, followed by a conversation which ends when the destination number hangs up or the caller presses “##,” in which case announcement 1362 is played. Regardless of whether announcement 1362,1358, or 1360 is played, the caller is allowed to place another call by cycling back to block 1346. The caller gets out of the cycle by saying “account menu,” which begins execution in FIG. 13c, or by hanging up or saying “good-bye,” which ends the callback application.

If, in block 1348, the subscriber says, “account menu,” control is transferred to FIG. 13c, via transfer block 1368. If this is the first time the subscriber has reached this portion of the call (n=1 means this is the first time), block 1369 plays the prompt, “account menu” and block 1370 plays the long prompt shown next to “n=1” and the help announcement in block 1375. If this is not the first time (n>1), block 1369 is skipped and block 1370 plays “What would you like to do?” At this point and at other points in the call flow, a distinction is made between the first (n=1) and subsequent (n>1) calls so that the subscriber will be given more information the first time, but not bothered with long prompts thereafter.

After the initial prompt(s) from blocks 1369 and 1370 complete, a speech recognizer listens for the caller's response and block 1371 (QA4) takes action depending on the recognized response. If the caller says, “continue call,” control goes to the Callback Start Dialog (FIG. 13b). If the caller says, “account ID,” block 1374 tells the caller his/her account ID and control returns to block 1370. If the caller says, “service information,” block 1372 plays the help information shown and control returns to block 1370. If the caller says, “help,” the help script in note 1375 is played and block 1371 listens for another selection from the caller. Since the penalty for the speech recognizer making a mistake is small in QA4, note 1375 specifies that there is no confirmation in step in QA4 (block 1371).

In FIG. 13b, if block 1335 determines that the trial period has expired, control goes to FIG. 13d via transfer blocks 1336 and 1376. FIG. 13b attempts to collect billing information to convert the trial subscriber to a paying subscriber. This attempt begins by playing prompt 1378. Block 1380 then attempts to collect the credit card number. There are multiple valid strategies for collecting a credit card number, though the strategy shown here uses the MS (Microsoft) credit card number collector on the Microsoft Speech Server. Block 1382 then asks for the credit card security code and QA5 (block 1384) listens for and attempts to recognize the security code. QA5 (block 1384) repeats the code to confirm and responds to the word “help,” as specified in note 1377. In block 1386, the MS (Microsoft) credit card date collector on the Microsoft Speech Server asks for and collects the expiration date from the caller. In block 1389, the MS (Microsoft) zip code collector on the Microsoft Speech Server collects a zip code from the caller. Decision block 1390 attempts to verify the credit card based on the number, security code, expiration date, and zip code. If the credit card cannot be verified, the caller is notified using the announcement in block 1388 and is invited to try another card starting again in block 1380. If the credit card checks out, the caller is given the good news in block 1391 and taken via transfer block 1392 to the Callback Start Dialog in FIG. 13b. Although Microsoft Speech Server routines are used in FIG. 13d to collect credit card information, it is to be understood that other methods are know in the art for collecting billing information from a customer and may be used in the context of the current invention.

If decision block 1338 in FIG. 13b determines that the billing information is out of date or that the account is otherwise not in good standing, the diagram in FIG. 13e is executed, starting with entry block 1393. Decision block 1395 determines whether the problem is an issue with credit. If the problem is an issue with credit, prompt 1398 plays. Otherwise prompt 1396 plays. In a first embodiment of the current invention, the callback server hangs up and terminates the call in block 1399 or 1397, respectively, as shown in FIG. 13e. In a second embodiment, one or both of the “End” blocks in FIG. 13e are replaced with transfers to a billing correction system that attempts to update or correct the billing problems so that the subscriber can continue to use and be billed for the service. Said billing correction system may be the Trial Expired dialog shown in FIG. 13d, another automated system, a live sales or customer service agent, or a combination of the above.

In one embodiment of the current invention, the callback service is used primarily to place calls, where the destination is, for example, a spoken or dialed telephone number. In an alternate embodiment of the current invention, the callback service connects the caller to a communication assistant that allows the caller to then perform a wide range of tasks, of which placing calls may be one task. An example of a communication assistant is Mandi, a service offered by SpeechPhone. Once connected to the communication assistant, the caller can place calls (including sequence calls), listen to email, check voicemail, and any of a number of offered actions.

An example of how a communication assistant is used with a callback service is shown in FIG. 14. A call is received from a caller and is answered in block 1410. The callback system collects the caller ID in block 1420. Block 1430 determines whether the caller is a subscriber and treats non-subscribers according to policies established by the service provider. In block 1440, the callback system calls the subscriber and the subscriber answers in block 1450. Note that details of operation of blocks 1410-1450 are described in more detail in descriptions related to previous figures. For example, as with blocks by the same name in other figures, blocks 1420 and 1430 are described in detail in FIGS. 4-6.

When the subscriber answers, he/she is connected to the communication assistant. This connection is handled differently depending on the system architecture, but in a first embodiment of the invention, the callback system includes communication assistant capabilities, so the subscriber essentially answers a call placed to him/her by the communication assistant. In this first embodiment, block 130 in FIG. 1 and block 1070 in FIG. 10 include communication assistant capabilities. In a second embodiment, the callback system transfers the call to a communication assistant using a blind transfer, supervised transfer, hairpin connection, multi-user bridge (such as a three-way call), or other means so that the subscriber is connected to the communication assistant. In this second embodiment, the communication assistant is a separate entity shown as block 150 in FIG. 1 and block 1090 in FIG. 10.

In block 1460, the communication assistant prompts the caller. The prompt may be specific (i.e. “Please dial the number now.”) or, in the case of a communication assistant with advanced features, the prompt may be general (i.e. “What would you like to do?”). The subscriber responds to the prompt in block 1470 and the communication assistant recognizes and responds to the request in block 1480.

In one embodiment of the invention (one in which decision block 1490 and path 1495 are omitted), as soon as the communication assistant fills the subscribers request, the call ends. In another, usually more useful, embodiment of the invention, the call ends only if the subscriber ends the call; otherwise the communication assistant continues to provide additional services to the subscriber by looping the application back to block 1460 via path 1495. Each time a given task is completed, the communication assistant prompts the subscriber to choose another task. The call ends when decision block 1490 determines that the subscriber has taken action to end the call such as hanging up, pressing a disconnect DTMF sequence such as “**9,” or saying “good-bye.”

Features offered by the communication assistant may be few or many, depending on how much the subscriber is willing to pay and which services the service provider is interested in offering. Examples of services that may be offered may include one or more of the following:
(1) Dial by spoken or dialed number. Example command: “1-630-852-3537.”
(2) Speed dialing using DTMF codes. Example: Dial 12 (speed dial connects the subscriber to a telephone number associated with speed dialing code “12”).
(3) Voice name dialing. The subscriber says a name and the communication assistant connects the subscriber to a telephone number associated with the name. The association between name and number may be a public directory, a company directory, a contact list owned by the subscriber, or other directory.
(4) Change call forwarding options. Example commands: “Forward my calls to 630-852-3537.” “Cancel call forwarding.” “Block all calls.”
(5) Start a conference call. Example command: “Call the management team.” (A conference call is set up by calling members of the management team and bridging the calls together. The identities and telephone numbers of the management were determined previously.)
(6) Emergency broadcast—places a call to multiple destinations, where a telephone number for each destination is contained in a specified list.
(7) Broadcast voicemail—leaves voicemail in multiple mailboxes, where each mailbox identifier is contained in a specified list.
(8) Listen to voicemail. Example commands: “Get voicemail.” “Listen to message number three.” “Delete message.”
(9) Personal directory: Example commands: “Get a number for John Smith.” “Get an email address for John Smith.” (John Smith is a person in the subscriber's contact list as recorded in a personal directory such as Microsoft Outlook.)
(10) Listen to email. This service uses TTS to read email over the phone using a synthetic voice. Example commands: “Listen to email.” “Read message number two.” “Read header number four.”
(11) Wakeup call. The subscriber picks a time and the callback services calls the subscriber at the specified time. Example command: “Schedule a wakeup call at 6:30 a.m. tomorrow.”
(12) Directory assistance. If the subscriber says, for example, “Look up a number” or “directory assistance,” the subscriber is connected to a live or automated system for looking up a number in a public directory. Once the number is found, the subscriber optionally is given the choice to have the number automatically connected.
(13) Concierge service. If the subscriber says, for example, “concierge,” the subscriber is connected to a live attendant that can perform a wide range of deluxe services such as looking up directions to a given location, adding names to the subscriber's contact list, finding theater or concert tickets, and making travel or dining reservations.
(14) Send email. The subscriber can send email as an audio attachment or as text transcribed using ASR.
(15) Send a text message. The subscriber can send a text message such as an SMS message by speaking the message, and the message is transcribed using ASR and/or using live agents.

### Alternative Embodiments

One useful variation on the callback service is to insert advertisements, played to the caller and/or destination at certain parts of the call flow. These ads may be simple announcements promoting a product or service or they may be offers to actually sign up the subscriber on the spot or connect the subscriber to a sales agent. Examples of points in the call flow where advertisements are possible include:
(1) After the callback service calls the subscriber and the subscriber answers (block 350 in FIG. 3).
(2) Before connecting the subscriber to the destination (before block 370 in FIG. 3).
(3) While the subscriber is waiting for the destination to answer the call (in block 370 in FIG. 3 and blocks 930 and 940 in FIG. 9).
(4) While the destination is waiting for the subscriber to answer the call (block 960 and 970 in FIG. 9).
(5) After the destination hangs up and before the subscriber is prompted to specify another destination (between block 760 and block 710 in FIG. 7).
(6) As part of the survey (blocks 1316-1322 in FIG. 13a).

The above points are only examples; there are other points in the call flow where an advertisement may be inserted. If the advertisement offers to sign up the subscriber, the callback server may do one or more of the following: configure the service to be subscribed, setup up billing for the service so that the subscriber will be charged, and/or transfer the subscriber to a sales agent.

Another useful variation on the callback service is to perform retries when the destination is unavailable (busy, a cell phone out of the service area, or otherwise unreachable). With this variation, the subscriber may hang up and the callback service continues to try calling the destination, then, if successful, calls the subscriber back. An example method for offering retries is as follows:
(1) A caller calls the callback system.
(2) The callback system calls the caller back.
(3) The callback system collects a destination number, either before or after the callback (step 2).
(4) The callback system attempts to call the destination.
(5) The callback system determines that the destination is busy or otherwise unavailable.
(6) The callback system advises the caller that the destination is unavailable and provides instructions (for example, that the caller should hang up and that the callback system will try every five minutes for 30 minutes).
(7) The callback system continues to attempt to call the destination.
(8) If the destination is reached, the callback system calls the caller.
(9) The callback system connects the caller to the destination.

It is to be understood that this application discloses a system and method for allowing callers to place outbound calls by taking inbound calls from a callback system. While the invention is particularly illustrated and described with reference to example embodiments, it will be understood by those skilled in the art that various changes in form, details, and applications may be made therein.

What is claimed is:

1. A method for placing telephone calls, the method comprising:
receiving a first call from a caller;
automatically detecting said caller's telephone number or equivalent identifier;
determining whether said caller is a subscriber;
placing a second call to said subscriber upon determining that said caller is a subscriber;
collecting a destination identifier from said subscriber; and
connecting said subscriber to said destination.

2. The method in accordance with claim 1 further comprising the step of offering said caller a subscription upon determining that said caller is not a subscriber.

3. The method of claim 2 wherein said subscription includes a free trial period.

4. The method in accordance with claim 2 further comprising the step of collecting at least one voice sample from said caller.

5. The method in accordance with claim 2 further comprising the step of activating said caller's subscription account as part of said first call.

6. The method in accordance with claim 2 further comprising the step of collecting billing information from said caller.

7. The method in accordance with claim 2 further comprising the step of offering, in addition to said subscription, one or more additional opportunities.

8. The method of claim 7 wherein said additional opportunities include one or more of the following: telephone service, cell phone service, landline phone service, communication assistant service, or travel service.

9. The method of claim 1 wherein said collecting a destination identifier occurs during said second call to said subscriber.

10. The method of claim 1 wherein said collecting a destination identifier occurs during said first call from said caller.

11. The method of claim 10 wherein said placing said second call to said subscriber and connecting said subscriber to said destination occur simultaneously.

12. The method of claim 11 further comprising the step of playing an announcement to said caller or said destination, whichever answers first.

13. The method of claim 1 wherein said collecting a destination identifier uses one or more of the following means: collecting a DTMF string, collecting a voice sample, receiving an SMS message, receiving a text message, receiving an instant message, or receiving an email message.

14. The method of claim 1 further comprising the step of connecting said caller to additional destinations using sequence calling.

15. The method of claim 1 wherein said first call is answered only upon determining that said caller is not a subscriber.

16. The method of claim 1 further comprising the step of said caller becoming a subscriber by one or more of the following means: signing up on a web site, signing up as part of receiving a call from a telemarketer, calling a live attendant and/or automated subscription service at a number other than the one used to place said first call, sending an email message, using an automated subscription system, or connecting said caller to a live attendant.

17. The method of claim 1 wherein said automatically detecting said caller's telephone number or equivalent identifier comprises one or more of the following: detecting Caller ID or ANI, detecting the dialed number or equivalent identifier, prompting the caller and listening for a voice or DTMF response, receiving an SMS message, receiving a text message, receiving an instant message, or receiving an email message.

18. The method of claim 1 wherein said caller and/or destination uses one or more of the following devices: analog telephone, digital telephone, wireless phone, Wi-Fi phone, cell phone, Wi-Max phone, peer-to-peer phone, automated system, VoIP phone, conference calling bridge, softphone, or video phone.

19. The method of claim 1 wherein VoIP is used for one or more of the following connections: a connection to said caller during said first call, a connection to said caller during said second call, a connection to said destination during said second call, a connection to said communication assistant during said second call.

20. The method of claim 1 further comprising the step of greeting said caller by name.

21. The method of claim 1 further comprising the step of playing an advertisement.

22. The method of claim 21 further comprising the step of signing up a caller and/or destination, as part of a current call, upon said caller and/or destination responding to said advertisement.

23. The method of claim 1 wherein the step of connecting said caller to said destination further comprises a step of determining whether said destination is available.

24. The method of claim 23 further comprising the step of making more than one connection attempt upon determining that said destination is not available.

25. A method for placing telephone calls, the method comprising:
receiving a first call from a caller;
placing a second call to said caller in response to said first call;
collecting at least one voice sample from said caller; and
connecting said caller to a destination.

26. The method of claim 25 wherein said voice sample is a telephone number or equivalent identifier.

27. The method of claim 25 wherein said voice sample is a name.

28. The method of claim 25 further comprising the step of prompting said caller for a telephone number or equivalent identifier during said first call and receiving a response from said caller.

29. The method of claim 28 wherein said response from said caller specifies the telephone number or equivalent identifier of said destination.

30. A method for connecting a caller to a communication assistant, the method comprising:
receiving a first call from a caller;
automatically detecting said caller's telephone number or equivalent identifier;
placing a second call to said caller in response to said first call;
connecting said caller to a communication assistant.

31. The method in accordance with claim 30 further comprising the step of collecting at least one voice sample from said caller.

32. The method in accordance with claim 31 further comprising the step of said communication assistant connecting said caller to a destination.

33. The method in accordance with claim 30 wherein said communication assistant performs one or more of the following functions: connecting said caller to a destination based on a spoken or dialed number, speed dialing using DTMF codes, voice name dialing, changing call forwarding options, starting a conference call, emergency broadcast, broadcast voicemail, listening to voicemail, accessing a personal directory, listening to email, placing wakeup call, directory assistance, concierge service, sending email, sending a text message, sequence calling, or attempting to sell said subscriber new services.
